(19) United States
(12) Patent Application Publication
(10) Pub. No.: US 2016/0271860 A1
(43) Pub. Date: Sep. 22, 2016

(54) Production Method of Fiber-Reinforced Plastic

(71) Applicant: TEIJIN LIMITED, Osaka-shi (JP)

(72) Inventors: Yusuke Mashima, Osaka-shi (JP); Takuo Kanzaki, Osaka-shi (JP); Masato Oogi, Osaka-shi (JP)

(73) Assignee: Teijin Limited, Osaka-shi (JP)

(21) Appl. No.: 14/392,154

(22) PCT Filed: Jun. 11, 2015
(86) PCT No.: PCT/JP2015/066900

§ 371 Date: Dec. 23, 2015

(30) Foreign Application Priority Data
Jul. 1, 2014 (JP) 2014-136033

(51) Int. Cl. B29C 51/08

(52) U.S. Cl. CPC B29C 51/082; B29K 2101/12

(57) ABSTRACT

A production method for producing a sheet-like fiber-reinforced plastic from a composite composition containing a thermoplastic resin and a reinforcing fiber, wherein the bulk density of the composite composition is increased at not more than a temperature 30° C. lower than the melting point when the thermoplastic resin is crystalline or at not more than a temperature 100° C. higher than the glass transition temperature when the thermoplastic resin is amorphous.

### TECHNICAL FIELD

The present invention relates to a production method for producing a sheet-like fiber-reinforced plastic from a composite composition containing a thermoplastic resin and a reinforcing fiber.

### BACKGROUND ART

A fiber-reinforced plastic used for a fiber-reinforced thermoplastic resin molding material includes a thin sheet-like plastic obtained by heating and pressing a composite composition containing a thermoplastic resin and a reinforcing fiber. The production method of such a sheet-like fiber-reinforced plastic has been proposed, for example, in Patent Document 1.

Patent Document 1 describes a method where a web (corresponding to the composite composition of the present invention) composed of an opened reinforcing fiber and a thermoplastic resin is shaped into sheet form by a so-called double belt press method. In this technique, the web is preheated at a temperature of ±20° C. relative to the melting point of the thermoplastic resin at a stage prior to feeding to the double belt press and thereafter, the web is pressed by the top roll of the double belt press while further rapidly heating the web.

Since the web fed to the double belt press is preheated, the resin flows at the pressing stage to increase the density (reducing the material thickness).

Patent Document 2 describes a method for producing a fiber-reinforced thermoplastic resin material, when a fiber-reinforced thermoplastic plastic is produced, by sealing and pressing a side thereof so as to reduce wasting in the edge part.

In Patent Document 3, at the time of production of a fiber-reinforced thermoplastic resin sheet, a pre-shaped product is previously prepared and then subjected to double belt press molding so as to prevent fluctuation of the fiber weight content and allow no outflow of the molten resin.

### CITATION LIST

### Patent Document

Patent Document 1: JP-A-5-245866 (the term “JP-A” as used herein means an “unexamined published Japanese patent application”)

Patent Document 2: JP-A-6-190944

Patent Document 3: JP-A-9-277387

### SUMMARY OF THE INVENTION

### Problems that the Invention is to Solve

However, in the production method of Patent Document 1, since the web is preheated to ±20° C. relative to the melting point of the thermoplastic resin, there is a problem that a large amount of resin flows out at the time of shaping into sheet form. Here, the large amount outflow tends to increase variation in the fiber volume content, or the like, of the fiber-reinforced plastic.

In the production method described in Patent Document 2, a sealing device needs to be newly provided, and it causes not only increase of the cost but also increase of the number of control factors in the production facility. In the method described in Patent Document 3, a pre-shaped product needs to be once prepared, and since this leads to add one production step, the cost increases as well.

Considering these problems, an object of the present invention is to provide a production method of a fiber-reinforced plastic, where a composite composition can be shaped into sheet form while suppressing an outflow of a thermoplastic resin.

### Means for Solving the Problems

As a result of intensive studies, the present inventors have found that the above-described object can be attained by the following means. The present invention has been accomplished based on this finding.

1. A production method for producing a sheet-like fiber-reinforced plastic from a composite composition containing a thermoplastic resin and a reinforcing fiber,
wherein a bulk density of the composite composition is increased at not more than a temperature 30° C. lower than a melting point when the thermoplastic resin is crystalline or at not more than a temperature 100° C. higher than a glass transition temperature when the thermoplastic resin is amorphous.

2. The production method of a fiber-reinforced plastic according to 1,
wherein a step of increasing the bulk density is finished before 20% or more of the thermoplastic resin flows out relative to the composite composition prior to increase of the bulk density.

3. The production method of a fiber-reinforced plastic according to 1 or 2,
wherein the composite composition increased in the bulk density is heated at a temperature the same as or higher than the melting point when the thermoplastic resin is crystalline, or at a temperature the same as or higher than the glass transition temperature or the temperature at the time of increasing the bulk density, whichever is higher, when the thermoplastic resin is amorphous.

4. The production method of a fiber-reinforced plastic according to 3,
wherein the heating is performed while maintaining a state of the bulk density being increased.

5. The production method of a fiber-reinforced plastic according to any one of 1 to 4,
wherein the reinforcing fiber is a chopped discontinuous fiber.

6. The production method of a fiber-reinforced plastic according to any one of 1 to 4,
wherein the reinforcing fiber contains chopped fibers randomly arranged in a two-dimensional direction.

7. The production method of a fiber-reinforced plastic according to any one of 1 to 4,
wherein the reinforcing fiber is a unidirectional continuous fiber.

8. The production method of a fiber-reinforced plastic according to any one of 1 to 7,
wherein the step of increasing the bulk density is performed on the composite composition that is moving.

9. The production method of a fiber-reinforced plastic according to any one of 1 to 8,
wherein a thickness of the composite composition satisfies the following formula (x):

α=weight per unit area of composite composition/{(density of thermoplastic resin*Wm+density of reinforcing fiber*Wf)*thickness of composite composition} formula (x)
wherein Wm represents weight ratio of the thermoplastic resin contained in the composite composition,
Wf represents weight ratio of the reinforcing fiber contained in the composite composition, and
α is from 0.020 to 0.82.

10. The production method of a fiber-reinforced plastic according to any one of 1 to 9,
wherein a thickness of the fiber-reinforced plastic satisfies the following formula (y):

β=weight per unit area of composite composition/{((density of thermoplastic resin*Wm′+density of reinforcing fiber*Wf′)*thickness of fiber-reinforced plastic} formula (y)
wherein Wm′ represents weight ratio of the thermoplastic resin contained in the fiber-reinforced plastic,
Wf′ represents weight ratio of the reinforcing fiber contained in the fiber-reinforced plastic, and
β is 0.82 or more.

### Advantage of the Invention

In the production method of the present invention, the density of the composite composition is increased in a state of being difficult for the thermoplastic resin to flow, and therefore an outflow of the thermoplastic resin is suppressed.

### BRIEF DESCRIPTION OF THE DRAWINGS

FIG. 1 is a schematic view showing the apparatus for producing a fiber-reinforced plastic according to embodiment 1.

FIG. 2 is a schematic view showing one example of the method for producing a composite composition and a fiber-reinforced plastic according to embodiment 2.

FIG. 3A is a view for explaining the process of producing a fiber-reinforced plastic from a composite composition; and FIG. 3B is a view for explaining the temperature profile of the composite composition before and after increasing the bulk density (vertical axis: temperature, horizontal axis: each zone and distance).

FIG. 4 is a view showing the thickness of the composite composition before and after increasing the bulk density in the process of producing the sheet-like fiber-reinforced plastic of FIGS. 3A and 3B (vertical axis: thickness of composite composition (mm), horizontal axis: distance X).

### MODE FOR CARRYING OUT THE INVENTION

### Outline

The fiber-reinforced plastic according to the present invention is produced in a sheet form from a composite composition containing a thermoplastic resin and a reinforcing fiber.

### <Composite Composition>

### 1. Thermoplastic Resin

### (1) Kind

The thermoplastic resin for use in the present invention is used as a matrix component of the composite composition.

The thermoplastic resin contained in the composite composition includes a polyolefin resin, a polystyrene resin, a polyamide resin, a polyester resin, a polyacetal resin (polyoxymethylene resin), a polycarbonate resin, a (meth)acrylic resin, a polyarylate resin, a polyphenylene ether resin, a thermoplastic polyimide resin, a polyether nitrile resin, a phenoxy resin, a polyphenylene sulfide resin, a polysulfone resin, a polyketone resin, a polyether ketone resin, a thermoplastic urethane resin, a fluororesin, a thermoplastic polybenzimidazole resin, and the like.

The polyolefin resin includes a polyethylene resin, a polypropylene resin, a polybutadiene resin, a polymethylpentene resin, a vinyl chloride resin, a vinylidene chloride resin, a vinyl acetate resin, polyvinyl alcohol resin, and the like.

The polystyrene resin includes a polystyrene resin, an acrylonitrile-styrene resin (AS resin), an acrylonitrile-butadiene-styrene resin (ABS resin), and the like.

The polyamide resin includes a polyamide 6 resin (nylon 6), a polyamide 11 resin (nylon 11), a polyamide 12 resin (nylon 12), a polyamide 46 resin (nylon 46), a polyamide 66 resin (nylon 66), a polyamide 610 resin (nylon 610), and the like.

The polyester resin includes a polyethylene terephthalate resin, a polyethylene naphthalate resin, a polybutylene terephthalate resin, a polytrimethylene terephthalate resin, a liquid crystal polyester, and the like.

The (meth)acrylic resin includes polymethyl methacrylate and the like. The modified polyphenylene ether resin includes a modified polyphenylene ether and the like. The thermoplastic polyimide resin includes a thermoplastic polyimide, a polyamideimide resin, a polyether imide resin, and the like.

The polysulfone resin includes a modified polysulfone resin, a polyether sulfone resin, and the like. The polyether ketone resin includes a polyether ketone resin, a polyether ether ketone resin, a polyether ketone ketone resin, and the like. The fluororesin includes polytetrafluoroethylene and the like.

The thermoplastic resin used in the composite composition may be only one kind of a thermoplastic resin or two or more kinds thereof. The embodiment where two or more kinds of thermoplastic resins are used in combination includes, for example, an embodiment where thermoplastic resins differing from each other in the softening point, melting point, glass transition temperature, or the like are used in combination, and an embodiment where thermoplastic resins differing from each other in the average molecular weight are used in combination, but is not limited thereto.

The thermoplastic resin may be a new material (so-called, a virgin material) or a recycled material, or may be a mixture thereof.

### (2) Form

The form of the thermoplastic resin is not particularly limited. The form includes a particle form, a lump form, a fiber form, a sheet form, and the like. Specific shapes of the particle form include, for example, a spherical form and an oval spherical form. The lump form includes a spherical form, an oval spherical form, a columnar form, a rectangular form, and the like. The particle form indicates a shape smaller than one of the lump form. Specifically, one having a diameter of less than 3 mm is referred to as a particle, and one having a diameter of 3 mm or more is referred to as a lump.

### 2. Reinforcing Fiber

### (1) Kind

The reinforcing fiber includes a carbon fiber, a glass fiber, an aramid fiber, a boron fiber, a polyethylene fiber, and the like. In view of specific mechanical properties, a carbon fiber may be suitably used, and in view of the cost, a glass fiber may be suitably used. The reinforcing fiber used in the composite composition may be only one kind of a fiber or two or more kinds of fibers.

As the carbon fiber, a polyacrylonitrile (PAN)-based carbon fiber, a petroleum or coal pitch-based carbon fiber, a rayon-based carbon fiber, a cellulose-based carbon fiber, a lignin-based carbon fiber, a phenol-based carbon fiber, a vapor-grown carbon fiber, and the like are known in general, and any of these carbon fibers may be suitably used.

### (2) Fiber Length

The fiber length of the reinforcing fiber is not particularly limited. More specifically, the reinforcing fiber may be a continuous fiber or a fiber cut into a fixed length or an indefinite length (hereinafter, sometimes simply referred to as “chopped fiber”) or may be a combination of a continuous fiber and a chopped fiber. In the chopped fiber with a fixed length, the fixed length may be one kind of a length or a plurality of kinds of lengths.

### (3) Fiber Form

The form of the reinforcing fiber may be a fiber bundle formed by bundling single yarns or be only a single yarn, or may contain both. In the case of a fiber bundle, the number of fibers constituting the bundle is not particularly limited, and the number of fibers in the fiber bundle may be one kind of a number or a plurality of kinds of numbers.

### (4) Orientation

The reinforcing fiber may be oriented in one direction, two directions, three or more directions, or random directions, in the two-dimensional direction (in-plane thickness direction of the fiber-reinforced plastic). Here, random orientation in the two-dimensional direction means that the reinforcing fiber is a discontinuous reinforcing fiber and in two-dimensional directions orthogonal to each other, the difference of orientations of reinforcing fibers in the directions is small.

Furthermore, the reinforcing fiber may be oriented randomly in three dimensions. Random orientation in three dimensions means that in three-dimensional directions orthogonal to each other, the difference of the orientations of carbon fibers in the directions is small.

### 3. Proportion of Thermoplastic Resin

The content of the thermoplastic resin in the composite composition is preferably from 5 to 1,000 parts by weight per 100 parts by weight of the reinforcing fiber. If the content is less than 5 parts by weight, the function of binding reinforcing fibers is reduced and when a molded product is formed, a non-impregnated portion is present. On the contrary, if the content exceeds 1,000 parts by weight, the reinforcing effect of the reinforcing fiber is reduced. The content of the thermoplastic resin is more preferably from 20 to 500 parts by weight per 100 parts by weight of the reinforcing fiber.

### 4. Thickness of Composite Composition

The thickness of the composite composition for use in the present invention is not particularly limited but preferably satisfies the following formula (x).

α=weight per unit area of composite composition/{(density of thermoplastic resin*Wm+density of reinforcing fiber*Wf)*thickness of composite composition} formula (X)
Wm: weight ratio of the thermoplastic resin contained in the composite composition
Wf: weight ratio of the reinforcing fiber contained in the composite composition
α: 0.020 to 0.82.

This is because, when the thickness of the composite composition is less than 82% relative to the theoretical thickness of the composite composition where a gap is not present (when α is less than 0.82), the outflow amount of the thermoplastic resin in the step of increasing the bulk density is likely to be suppressed. On the other hand, when the thickness is 2.0% or more (when α is 0.020 or more), the bulk density of the composite composition is high, and the operability of the composite composition is not reduced. If the value of α is too small, the thermoplastic resin may flow out before the bulk density is increased (in other words, if α is too small, a chopped fiber bundle in which the bulk density is increased and the like does not obstruct the flow of the thermoplastic resin). Also for this reason, α is preferably 0.020% or more. The value of α is more preferably from 0.025 to 0.60, still more preferably from 0.045 to 0.30.

Here, Wf representing weight ratio of the reinforcing fiber contained in the composite composition is a ratio assuming that the total of the resin and the fiber, excluding other additive components, is 100% (the same applies to Wf later).

### 5. Production Method

As for the production method of the composite composition, various methods may be used according to the form or the like of the thermoplastic resin and fiber reinforcing. Meanwhile, the production method of the composite composition is not limited to the methods described below.

### (1) Production Example 1

In the case where the composite composition is constituted by a short fiber and a thermoplastic resin, the composition can be produced, for example, by depositing a short fiber-containing resin strip.

Meanwhile, when a plurality of discharge nozzles are arranged in the TD direction relative to a support moving in the MD direction, a longitudinally continuous composite composition with a predetermined width is obtained. The MD direction as used herein means the longitudinal direction (Machine Direction) of a sheet, and the TD direction means the width direction (Transverse Direction) of the sheet.

### (2) Production Example 2

In the case where a chopped fiber is used as the reinforcing fiber contained in the composite composition and the composition is constituted by a reinforcing fiber mat formed by randomly arranging chopped fibers mainly in the two-dimensional direction and a thermoplastic resin, the composite composition can be produced, for example, by sandwiching a fiber between a pair of thermoplastic resin-made sheet materials. Specifically, a reinforcing fiber in a chopped state (chopped fiber) is discharged from a discharge nozzle toward a sheet material in the lower part to form a reinforcing fiber mat, and a thermoplastic resin sheet material is arranged on the reinforcing fiber mat, whereby the composite composition is obtained.

### (3) Production Example 3

In the case where a chopped fiber is used as the reinforcing fiber contained in the composite composition and the composition is constituted by a reinforcing fiber mat formed by randomly arranging chopped fibers mainly in the two-dimensional direction and a thermoplastic resin, the composite composition can be produced, for example, by arranging a reinforcing fiber mat on a thermoplastic resin sheet material made of a thermoplastic resin and applying a molten thermoplastic resin (in the case of an amorphous resin, a softened thermoplastic resin) onto the reinforcing fiber mat. Specifically, a reinforcing fiber in a chopped state (chopped fiber) is discharged from a fiber discharge nozzle toward a thermoplastic resin sheet material in the lower part to form a reinforcing fiber mat, and a molten thermoplastic resin (in the case of an amorphous resin, a softened thermoplastic resin) is discharged from a resin discharge nozzle on the reinforcing fiber mat, whereby the composite composition is obtained.

Meanwhile, when a plurality of fiber discharge nozzles or resin discharge nozzles are arranged in the TD direction orthogonal to the MD direction relative to a sheet material moving in the MD direction, a longitudinally continuous composite composition with a predetermined width is obtained.

### (4) Production Example 4

In the case where the composite composition is constituted by a thermoplastic resin and a reinforcing fiber mat formed by aligning continuous reinforcing fibers in one direction, the composition can be produced, for example, by arranging a resin powder composed of a thermoplastic resin on a reinforcing fiber mat. Specifically, a resin powder is discharged from a discharge nozzle on a reinforcing fiber mat, whereby the composite composition is obtained. A resin strip may be used in place of the resin powder.

### <Fiber-Reinforced Plastic>

### (1) Configuration

The fiber-reinforced plastic in the present invention contains a thermoplastic resin and a reinforcing fiber each constituting a composite composition. The fiber-reinforced plastic may be constituted only by a thermoplastic resin and a reinforcing fiber of the composite composition or may be constituted by a thermoplastic resin and a reinforcing fiber of the composite composition and a material other than these materials.

The “sheet-like” means a material having a planar shape wherein when out of three dimensions (for example, length, width and thickness) indicating the size of the fiber-reinforced plastic, the smallest dimension is the thickness and the largest dimension is the length, the length is as large as 10 times or more the thickness.

The other material includes a thermoplastic resin, a reinforcing fiber, which are different from the materials constituting the composite composition, an inorganic material, and the like. The other material may be a reinforcing fiber which is the same reinforcing fiber as the reinforcing fiber constituting the composite composition but differs in the fiber length. In the case of using a fiber bundle as the reinforcing fiber, the fiber bundle may contain a fiber bundle differing in the number of fibers from the fiber bundle of the reinforcing fiber in the composite composition.

### (2) Thickness of Fiber-Reinforced Plastic

The thickness of the fiber-reinforced plastic in the present invention is not particularly limited but preferably satisfies the following formula (y).

β=weight per unit area of composite composition/{(density of thermoplastic resin*Wm′+density of reinforcing fiber*Wf)*thickness of fiber-reinforced plastic} formula (y)
Wm′: weight ratio of the thermoplastic resin contained in the fiber-reinforced plastic
Wf′: weight ratio of the reinforcing fiber contained in the fiber-reinforced plastic
β: 0.82 or more

When β is 0.82 or more (when the bulk density of the composite composition is 82% or more relative to the theoretical thickness of the composite composition where a gap is not present), the mechanical strength of the fiber-reinforced plastic or a shaped product obtained, for example, by press-molding the fiber-reinforced plastic is stabilized. The value of β is more preferably 0.9 or more.

### (3) Production Method

The fiber-reinforced plastic is made in a sheet form by using the above-described composite composition. As the method for production in a sheet form, various methods may be used in the step for increasing the bulk density.

The bulk density increasing step in the present invention is performed at not more than a temperature 30° C. lower than the melting point when the thermoplastic resin is crystalline or at not more than a temperature 100° C. higher than the glass transition temperature when the thermoplastic resin is amorphous. Hereinafter, not more than a temperature 30° C. lower than the melting point when the thermoplastic resin is crystalline, and not more than a temperature 100° C. higher than the glass transition temperature when the thermoplastic resin is amorphous, are sometimes simply referred to as “preheating temperature”.

In the step of increasing the bulk density of the present invention, the lower limit of the preheating temperature is not particularly limited but is preferably a temperature higher than room temperature, more preferably not less than a temperature 30° C. higher than room temperature. Heating at a temperature higher than room temperature facilitates the temperature control in the subsequent heating zone.

In the production method of a fiber-reinforced plastic of the present invention, from the standpoint of productivity, the fiber-reinforced plastic is preferably produced not batchwise but continuously. In the case of continuously producing a fiber-reinforced plastic, the composite composition comes to have a continuous form.

Here, the production method of a fiber-reinforced plastic by increasing the bulk density as used in the present invention means a production method of a fiber-reinforced plastic including a step of increasing the bulk density of the above-described composite composition.

The step of increasing the bulk density is accompanied by an outflow of the thermoplastic resin and is preferably finished before 20% or more of the thermoplastic resin flows out relative to the composite composition prior to increase of the bulk density.

### (i) Step Example 1

In the case where the composite composition is in a predetermined size, a compression device (press device) can be utilized. Specifically, a composite composition is arranged between a pair of upper and lower pressing faces of the compression device and thereafter, the paired pressing faces are moved close to each other, whereby the thickness of the composite composition can be reduced to increase the bulk density.

### (ii) Step Example 2

In the case where the composite composition has a lengthy shape and the composite composition is moving in a predetermined direction, a mold where space become narrower as it moves from the upstream side to the downstream side in the MD direction (a device for increasing the bulk density), can be utilized. Specifically, the composite composition is moved (passed) from the upstream side to the downstream side between mold parts with the spacing thereof getting narrower, whereby the thickness of the composite composition can be reduced to increase the bulk density.

The method for moving the composite composition includes, for example, an extraction system of extracting the composite composition in the mold from the downstream side, an extrusion system of extruding the composite composition from the upstream side, and a conveyor system of passing the composite composition placed on a movable body between mold parts together with the movable body.

### (iii) Step Example 3

In the case where the composite composition has a continuous form, a pair of rollers (forming one set) with the spacing thereof being adjusted can be utilized. For example, the composite composition is moved and passed between at least one set of rollers, whereby the bulk density of the composite composition can be increased. In the case of using a plurality of sets of rollers, the plurality of sets of rollers may be arranged such that the space between a pair of rollers becomes narrower as it moves from the upstream side to the downstream side in the direction of the composite composition movement.

### (iv) Step Example 4

In the case where the composite composition has a continuous form, a pair of belts with the spacing thereof being adjusted can be utilized (a so-called double belt press system). The composite composition is passed between belts arranged such that the belt spacing becomes narrower as it moves from the upstream side to the downstream side in the portion where the paired belts face each other, whereby the bulk density of the composite composition can be increased. The belt spacing can be adjusted by a roller or a supporting plate arranged on the back side of the belt.

### (v) Others

In Step Examples 1 to 4, for example, when the composite composition needs to be heated at the time of compression, a compression device, a mold, a roller, a belt, or the like each equipped with a heating means may be utilized. The heating may be performed before the step of increasing the bulk density or may be performed during the step of increasing the bulk density. The step of increasing the bulk density is not limited to Step Examples 1 to 4 and may be conducted by partially combining these step examples.

### (4) Utilization of Fiber-Reinforced Plastic

The fiber-reinforced plastic in the present invention may be utilized as a molding material for the production of a shaped product or may be utilized directly as a sheet material. In the case of use as a molding material, the fiber-reinforced plastic is molded using a press machine.

### Embodiment 1

In this embodiment, a carbon fiber cut into a predetermined length (hereinafter, referred to as “chopped fiber”) is used as the reinforcing fiber, and a powdered resin (hereinafter, referred to as “resin powder”) is used as the thermoplastic resin. In the composite composition, the chopped fiber and the resin powder may be randomly arranged. Here, a mat-like material having randomly arranged therein chopped fibers is sometimes referred to as a reinforcing fiber mat.

### 1. Composite Composition

### (1) Carbon Fiber

The fiber length, fiber diameter and form of the carbon fiber are the same also in “Embodiment 2”.

### (i) Fiber Length

The fiber length of the carbon fiber is not particularly limited but is preferably from 3 to 100 mm. If the fiber length is less than 3 mm, the mechanical properties of the carbon fiber cannot be effectively brought out, and the mechanical properties of the fiber-reinforced plastic may be impaired. If the fiber length exceeds 100 mm, it is difficult for a shaped product to have uniform mechanical strength.

The fiber length of the carbon fiber is more preferably from 5 mm to 60 mm. The fiber length is still more preferably from 8 mm to 50 mm, yet still more preferably from 10 mm to 40 mm.

As for the average fiber length of the carbon fiber, when carbon fiber is used by cutting it into a fixed length by means of a rotary cutter, or the like, the cut length is the average fiber length, and this is both a number average fiber length and a weight average fiber length. Assuming that the fiber length of individual carbon fibers is Li and the number of fibers measured is j, the number average fiber length (Ln) and the weight average fiber length (Lw) are obtained according to the following formula (3) and (4) (in the case of a fixed cut length, calculation of the number average fiber length (Ln) according to calculating formula (3) is also the calculation of the weight average fiber length (Lw)).

Ln=ΣLi/j (3)

Lw=(ΣLi²)/(ΣLi) (4)

Here, the measurement of the average fiber length in the present invention may be either measurement of the number average fiber length or measurement of the weight average fiber length.

### (ii) Fiber Diameter

The average fiber diameter of the carbon fiber is not particularly limited but is preferably from 3 μm to 12 μm, more preferably from 5 μm to 7 μm.

(iii) Form

The carbon fiber has a bundle form formed by collecting thousands to tens of thousands of filaments. The chopped fiber contained in the composite composition is roughly classified into a fiber bundle constituted by fibers of a critical number of single fiber or more, defined by formula (1), and a fiber other than that.

The “fiber other than that” includes a single yarn and a fiber bundle composed of a smaller number of fibers than the critical number of single fiber. The “fiber other than that” is hereinafter referred to as “single yarn or the like” so as to distinguish it from a fiber bundle of fibers of not less than a critical single fiber number. Furthermore, in order to distinguish between a chopped fiber merely cut into a predetermined length and a chopped fiber containing a fiber bundle constituted by fibers of the critical number of single fiber or more and a single yarn or the like, a chopped fiber containing the fiber bundle and a single yarn or the like is referred to as a chopped fiber bundle or the like.

Critical number of single fiber=600/D (1)

Here, “D” is the average fiber diameter (μm) of carbon single yarns.

The ratio of the fiber bundle is preferably from 20 Vol % to 99 Vol % relative to the total amount of carbon fibers in the composite composition. If the ratio of the fiber bundle is less than 20 Vol %, it is difficult to increase the bulk density, and the applied pressure when molding the fiber-reinforced plastic into a shaped product by using a press machine cannot be reduced. If the ratio of the fiber bundle exceeds 99 Vol %, a single yarn or the like are not contained and when a shaped product is formed, a shaped product excellent in the mechanical strength is not likely to be obtained. The ratio of the fiber bundle is more preferably 30 Vol % or more and less than 95 Vol %, still more preferably 50 Vol % or more and less than 90 Vol %.

The average number (N) of fibers in the fiber bundle is in the range defined by formula (2).

0.6*10⁴/D²<N<2.0*10⁵/D² (2)

Here, “D” is the average fiber diameter (μm) of carbon single yarns as described above.

The average number (N) of fibers is preferably from 1.0*10⁴/D² to 1.0*10⁵/D², more preferably from 5.0*10⁴/D² to 1.0*10⁵/D².

### (2) Thermoplastic Resin

The average particle diameter or the like of the resin powder are not particularly limited, but the average particle diameter is preferably from 200 μm to 900 μm. Because, the resin powder is allowed to readily enter a gap in the reinforcing fiber mat, which is produced by fiber bundles. The average particle diameter is more preferably from 500 μm to 600 μm.

### (3) Production Method

The composite composition is produced, for example, by discharging the chopped fiber bundle or the like and the resin powder on a support. At this time, when the support is continuously moved in the MD direction, a continuous mat continuing in the MD direction is formed. In addition, when a discharge nozzle is utilized for discharging the chopped fiber bundle or the like and the resin powder and a plurality of discharge nozzles are arranged in the TD direction orthogonal to the MD direction, a composite composition having a predetermined width in the TD direction and continuing in the MD direction is formed.

The production method of the composite composition 1 may be performed, for example, by referring to the description in International Publication No. 2013/094706 and includes a fiber feeding step of cutting a fed strand into a predetermined length and feeding it to a discharge nozzle, a resin feeding step of feeding a resin powder to the discharge nozzle, and a discharging step of mixing the fed chopped fiber and resin powder and discharging the mixture on a movable support.

### 2. Production Method of Fiber-Reinforced Plastic

### (1) Outline

The fiber-reinforced plastic is produced from the composite composition 1 above. The production method of the fiber-reinforced plastic includes a step of increasing the bulk density at not more than a temperature 30° C. lower than the melting point when the thermoplastic resin is crystalline or at not more than a temperature 100° C. higher than the glass transition temperature when the thermoplastic resin is amorphous. In this embodiment 1, the production method of the fiber-reinforced plastic includes, in addition to the step above, a heating step and a cooling step, and a production apparatus is utilized.

### (2) Production Apparatus

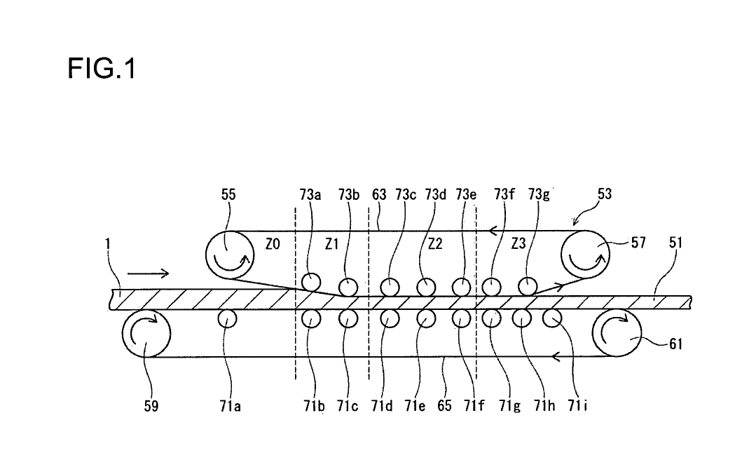

FIG. 1 is a schematic view showing the apparatus for producing a fiber-reinforced plastic according to embodiment 1.

The production apparatus 53 is a so-called double belt press and has upper and lower endless belts 63 and 65 facing each other and bridging one set of main rollers 55, 57, 59 and 61. Here, at least one endless belt is rotationally driven to rotate in the same direction in the opposing portion.

In the opposing portion, the front side and the rear side in the travel direction (MD direction) of the endless belts 63 and 65 are regarded as the downstream and the upstream, respectively, and while the composite composition 1 is fed from the upstream side, the fiber-reinforced plastic 51 is delivered from the downstream side.

The endless belt 65 arranged on the lower side is referred to as a lower endless belt 65, and the endless belt 63 arranged on the upper side is referred to as an upper endless belt 63. In addition, a plurality of sub-rollers 71 arranged on the back side of the lower-side endless belt 65 are referred to as lower sub-rollers 71, and a plurality of sub-rollers 73 arranged on the inner side of the upper endless belt 63 are referred to as upper sub-rollers 73.

The upper and lower endless belts 63 and 65 have a plurality of sub-rollers 71 and 73 on the inner side in the opposing portion, whereby fixed rotational trajectories are formed. As shown in FIG. 1, the upper sub-rollers 73 are arranged above the lower sub-rollers 71. In the upstream region, the spacing of both sub-rollers 71 and 73 becomes narrow as it moves from the upstream side to the downstream side. For example, in FIG. 1, the vertical spacing is reduced in the first two sub-rollers as counted from the upstream side, i.e., the upper and lower sub-rollers 71b, 73a, 71c and 73b, as it moves toward the downstream side. The vertical spacing is equal in the third and subsequent sub-rollers as counted from the upstream side, i.e., upper and lower sub-rollers 71d to 71i and 73c to 73g.

The region where upper and lower endless belts 63 and 65 face each other has at least a preheating zone Z1 on the upstream side. Here, the region where upstream-side two sub-rollers 71b, 71c, 73a and 73b are located and belong to the heating zone Z1. In embodiment 1, the region where endless belts 63 and 65 face each other has three zones of, from the upstream side, a preheating zone Z1, a heating zone Z2 and a cooling zone Z3.

Here, third to fifth sub-rollers 71d to 71f and 73c to 73e as counted from the upstream side belong to the heating zone Z2, and the subsequent sub-rollers 71g to 71i and 73f to 73g belong to the cooling zone Z3.

Each of sub-rollers 71 and 73 has a heating means. The temperature of the sub-rollers 71 and 73 in each of the zones Z1, Z2 and Z3 is set such that the temperature of a material (here, the composite composition 1) passing between upper and lower endless belts 63 and 65 becomes a predetermined temperature.

In Table 2, the temperature distribution of the composite composition before and after increasing the bulk density in the production apparatus are shown. As seen from the Table, the material temperature in the preheating zone Z1 is set to become a preheating temperature (hereinafter, unless otherwise specified, the temperatures of the zones Z1 to Z3 indicate the temperature of the composite composition itself).

The material temperature of the heating zone Z2 is set to heat the material at a temperature not less than the melting point when the thermoplastic resin is crystalline, or at a temperature not less than the glass transition temperature or the temperature at the time of increasing the bulk density, whichever is higher, when the thermoplastic resin is amorphous. Meanwhile, a temperature not less than the melting point when the thermoplastic resin is crystalline, and a temperature not less than the glass transition temperature or the temperature at the time of increasing the bulk density, whichever is higher, when the thermoplastic resin is amorphous, are sometimes referred to as “heating temperature”.

The material temperature in the cooling zone Z3 is set to become not more than a temperature 50° C. lower than the melting point when the thermoplastic resin is crystalline or become not more than a temperature 30° C. lower than the glass transition temperature when the thermoplastic resin is amorphous. Meanwhile, the range of not more than a temperature 50° C. lower than the melting point when the thermoplastic resin is crystalline, and the range of not more than a temperature 30° C. lower than the glass transition temperature when the thermoplastic resin is amorphous are sometimes referred to as “cooling temperature”.

### (3) Production Process

When the composite composition 1 is fed from the upstream side in the production apparatus 53, the step of increasing the bulk density is performed in the preheating zone Z1, a heating step is performed in the heating zone Z2, a cooling step is performed in the cooling zone Z3, and thereafter, the composition is delivered as a sheet-like fiber-reinforced plastic 51 from the downstream side.

In the preheating zone Z1, the space between upper and lower sub-rollers 71b, 73a, 71c and 73b is narrowed as it moves from the upstream side to the downstream side. The composite composition 1 passing through this zone Z1 is compressed, whereby the thickness of the composite composition 1 is reduced to increase the bulk density.

In this process, the composite composition 1 is made thin when the temperature of the composite composition 1 is in the range of a preheating temperature. Therefore, the resin powder (thermoplastic resin) in the composite composition 1 moves into a gap between randomly deposited chopped fiber bundles or the like, as a result, at least part of the gap is filled with the resin powder. Meanwhile, since the resin powder at the time of compression is not melted (in the case of an amorphous resin, not softened), the resin powder is kept from flowing out to the outside of the composite composition 1.

In the heating zone Z2, the spacing of upper and lower sub-rollers 71d to 71f and 73c to 73e is substantially constant and in this condition, the composite composition 1 with an increased bulk density is heated at a range of the “heating temperature”. The thermoplastic resin here is in a molten state (in the case of an amorphous resin, in a softened state; hereinafter the same), but since the spacing of sub-rollers 71d to 71f and 73c to 73e is constant, the pressure applied to the thermoplastic resin in a molten state is not changed.

The fiber-reinforced plastic is preferably produced while maintaining the increased bulk density in the heating zone Z2, and at this time, a pressure may or may not be applied to the composite composition 1 increased in the bulk density.

The chopped fiber bundle or the like with an increased bulk density obstructs the flow of the molten thermoplastic resin, and the outflow of the thermoplastic resin is thereby suppressed. As a result, the molten thermoplastic resin stays between the chopped fiber bundles or the like and penetrates therein.

In the cooling zone Z3, the spacing of upper and lower sub-rollers 71g to 71i and 73f to 73g is constant and in this condition, the composite composition 1 with an increased bulk density is cooled at the “cooling temperature”, whereby the molten thermoplastic resin is solidified and a fiber-reinforced plastic 51 is obtained.

### Embodiment 2

In embodiment 2, a carbon fiber cut into a predetermined length (hereinafter, referred to as “chopped fiber”) is used as the reinforcing fiber, and a thermoplastic resin sheet is used as the thermoplastic resin. In the composite composition, the thermoplastic resin sheet is put on the top surface of a mat-like reinforcing fiber mat having randomly arranged therein chopped fibers.

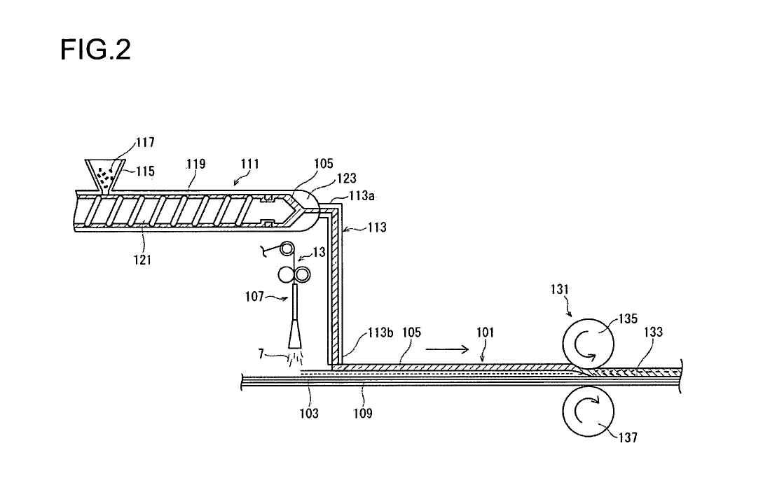

FIG. 2 is a schematic view showing one example of the method for producing a fiber-reinforced plastic according to embodiment 2, and the composite composition is formed by putting the thermoplastic resin sheet 105 on the reinforcing fiber mat 103. At this time, the thermoplastic resin sheet may be put and formed on the reinforcing fiber mat, or the reinforcing fiber mat may be formed on the thermoplastic resin sheet. In Embodiment 2, the reinforcing fiber mat is first formed.

The step of forming a reinforcing fiber mat in embodiment 2 is the same as that in the production method of a composite composition described in embodiment 1 except that a resin powder is not discharged. More specifically, a fed strand is cut into a predetermined length by means of a cutting unit and by utilizing the cut chopped fiber, a chopped fiber bundle is discharged from a discharge nozzle 107 on a conveyor 109 as a support, whereby the reinforcing fiber mat 103 is produced. Here, the conveyor 109 is moving in the MD direction (the right-hand direction in FIG. 2).

The step of forming a composite composition is performed using a screw extruder 111 and a T-die 113. In the extruder 111, a pulverized material 117 or a resin pellet fed from a hopper 115 is melted in a heating cylinder 119, and a screw body 121 is rotated to extrude the molten thermoplastic resin (hereinafter, sometimes referred to as “molten resin”; in the case of an amorphous resin, a softened resin; in “embodiment 2”, hereinafter the same) to the T-die 113 from a nozzle 123 of the heating cylinder 119.

The T-die 113 is a mold having a T-shaped passageway in its inside, and the resin sheet 105 is received from the end part (in FIG. 2, the upper end) 113a opposite to the side part in the vertical portion of the T shape and discharged from the side part of the T shape (in FIG. 2, the lower end) 113b into a linear shape extending in the direction orthogonal to the paper surface of FIG. 2.

The resin sheet 105 is flowed down onto the reinforcing fiber mat 103 on the conveyor 109 moving in the predetermined direction, i.e., the MD direction, whereby the thermoplastic resin sheet 105 is formed on the reinforcing fiber mat 103 in the moving direction of the conveyor 109 (in FIG. 2, the right-hand direction) and at the same time, the composite composition 101 is formed. Here, the temperature of the thermoplastic resin sheet 105 gradually drops due to transportation on the conveyor 109.

The composite composition 101 produced as above is fed to a device 131 shown in FIG. 2 for increasing the bulk density. As a result, a sheet-like fiber-reinforced plastic 133 with an increased bulk density is obtained.

The device 131 for increasing the bulk density is constituted by a pair of rollers 135 and 137 arranged on the front and back sides of the conveyor 109. Meanwhile, the roller 137 on the back side of the conveyor 109 functions also as a supporting roller for supporting the conveyor 109 from lower side and may be substituted, for example, by a supporting plate or the like.

The rollers 135 and 137 have a heating means, and the temperatures of the rollers 135 and 137 are set such that the temperature of the composite composition 101 becomes the preheating temperature. The stage of passing the composite composition 101 between the paired rollers 135 and 137 is a step of increasing the bulk density and corresponds to the preheating zone Z1 of embodiment 1. In addition, the stage after passage of the composite composition 101 is a cooling step and corresponds to the cooling zone Z3 of embodiment 1. In the case of embodiment 2, the heating zone Z2 of embodiment 1 is not present.

The composite composition 101 passes together with the conveyor 109 through the paired rollers 135 and 137. The spacing of the paired rollers 135 and 137 is set to be smaller than the sum of the thickness of the conveyor 109 and the thickness of the composite composition 101. Due to this, the composite composition 101 is subject to a compressive load and is increased in the bulk density. In the composite composition 101 just before feeding to the paired rollers 135 to 137, the bulk density is increased to some extent by the weight of the thermoplastic resin sheet 105.

The spacing of the paired rollers 135 and 137, from which the thickness of the conveyor 109 is subtracted, is preferably 1.1 times or more the thickness of the composite composition in the state of the gap being eliminated from the composite composition 101. This is because, when the spacing of the rollers 135 and 137 exclusive of the thickness of the conveyor 109 is 1.1 times or more, the gap in the reinforcing fiber mat 103 becomes large to alleviate a concern that the resin in the reinforcing fiber mat 103 has nowhere to go and flows out to the outside of the reinforcing fiber mat 103.

### EXAMPLES

### Evaluation of Outflow Amount of Resin

The outflow amount of the thermoplastic resin in the bulk density increasing step was evaluated as follows.

A: The outflow amount of the thermoplastic resin contained in the composite composition was less than 10%.

B: The outflow amount of the thermoplastic resin contained in the composite composition was from 10% to less than 20%.

C: The outflow amount of the thermoplastic resin contained in the composite composition was from 20% to less than 25%.

D: The outflow amount of the thermoplastic resin contained in the composite composition was from 25% to 30%.

E: The outflow amount of the thermoplastic resin contained in the composite composition exceeded 30%.

As for the outflow amount, the thermoplastic resin flowed outward from the carbon fiber mat was measured. In a case where, because of spreading of the thermoplastic resin and the reinforcing fiber mat at the same time, the thermoplastic resin did not flow out from the reinforcing fiber mat, this was judged as no occurrence of an outflow.

### (Weight Ratio of Reinforcing Fiber)

As for the weight ratio (Wf %) of the reinforcing fiber contained in the composite composition and the weight ratio (Wf′ %) of the reinforcing fiber contained in the fiber-reinforced plastic, each measurement target after measuring the weight W0 thereof was heated in air at 500° C. and for 1 hour, the resin component was removed by combustion, the weight W1 (g) of the remaining carbon fiber was measured, and the fiber weight content (Wf) was determined using the following formula (5).

In the case of measuring Wf′ of the fiber-reinforced plastic, without regard to the occurrence or non-occurrence of an outflow of the thermoplastic resin, Wf′ was determined by measuring, as the target sample, all fibers in the entire width direction (TD direction).

Wf(Wf′)=(weight W1 of carbon fiber/weight W0 of thermoplastic resin layer)*100 formula (5)

### (Value of α)

In each of Examples and Comparative examples, various composite compositions differing in the bulk density were prepared by adjusting the thickness of the composite composition. The value of α in each of Examples and Comparative Examples was controlled by the thickness of the composite composition.

### Example 1

A carbon fiber, “TENAX” (registered trademark) STS40-24KS (average fiber diameter: 7 μm, the number of single fibers: 24,000), produced by Toho Tenax Co., Ltd., which is a carbon fiber as the reinforcing fiber and is cut into an average fiber length 20 mm, was used as the chopped fiber, a nylon 6 resin, A1030 (crystalline resin having a melting point of 230° C.), produced by Unitika Ltd. was used as the resin, and a composite composition having randomly oriented therein carbon fibers was obtained based on the method described in WO2012/105080, pamphlet.

The fiber length of the chopped fiber bundle or the like of the obtained composite composition was 20 mm and out of the chopped fiber bundles or the like the ratio of the chopped fiber bundle having an average number (N) of fibers defined by formula (2) was 85 Vol % (the remaining is a single yarn or the like). In addition, the thickness of the composite composition was 100 mm, and the weight per unit area was 3,600 g/m² (0.36 g/cm²). The volume ratio of the reinforcing fiber in the composite composition was 35 vol %, and the weight ratio thereof was 46 wt % (the remaining is the thermoplastic resin). The composite composition produced is subjected to a step of increasing the bulk density, a heating step, and a cooling step.

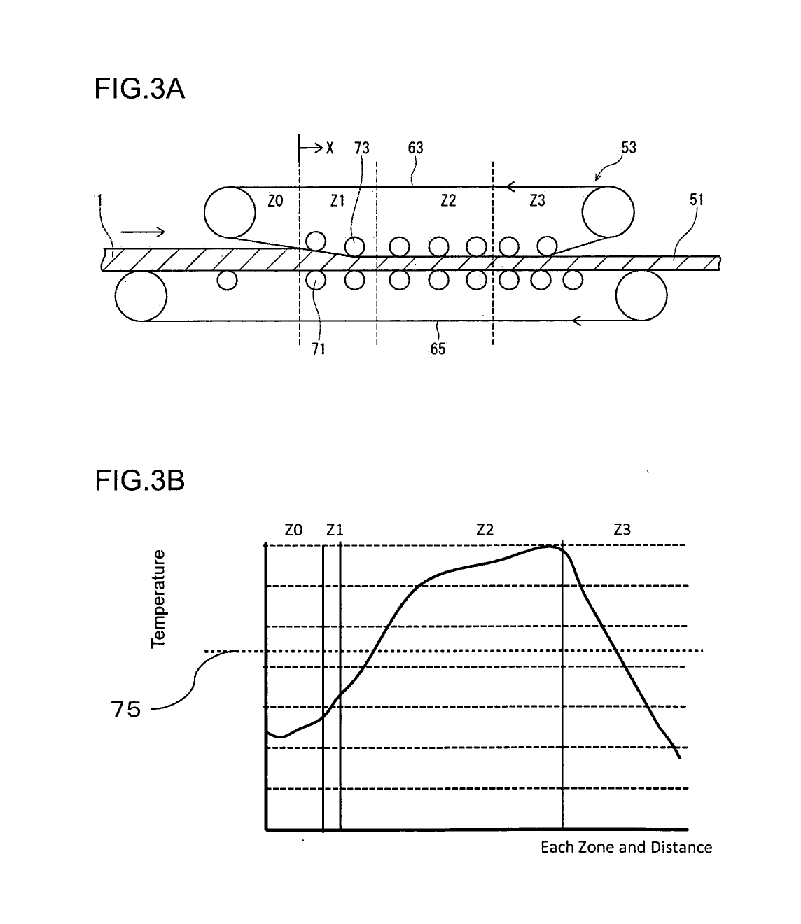

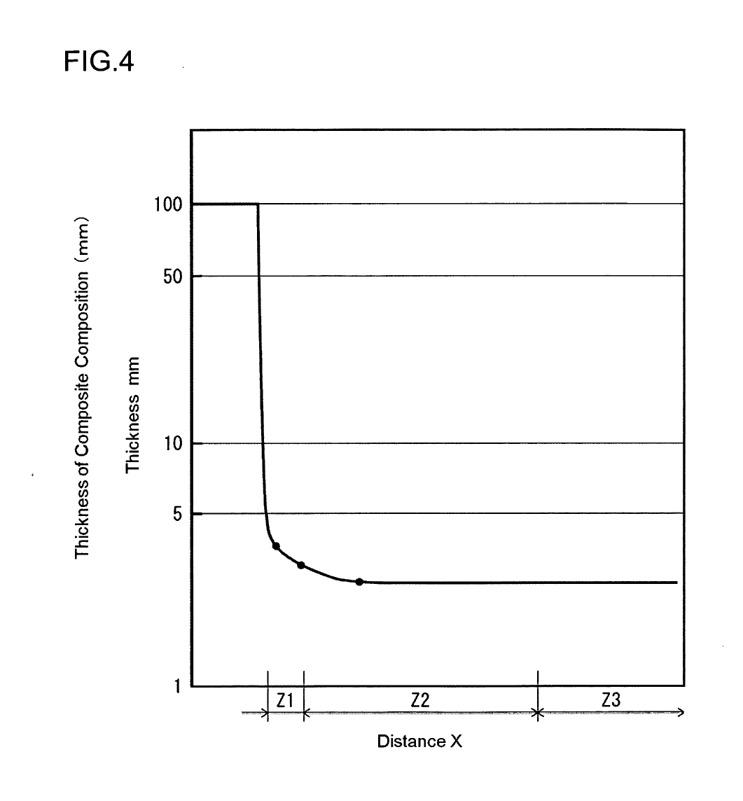

FIG. 3A is a view for explaining the process of producing a fiber-reinforced plastic from a composite composition, and FIG. 4 is a view showing the thickness in the bulk density increasing step of the composite composition before and after the bulk density is increased in the production process of FIG. 3A. FIG. 3B shows the temperature distribution in the production apparatus.

As shown in FIG. 3A, the composite composition is fed to the production apparatus 53. The production apparatus 53 has, as described above, three regions (zones Z1 to Z3) differing in the temperature distribution. The spacing of sub-rollers 71 and 73 arranged on the upper and lower sides substantially corresponds to the thickness of the fiber-reinforced plastic 51 shown in FIG. 3A. Here, the “distance X” in FIG. 4 is a distance which the composition moved to the downstream side based on the position where the step of increasing the bulk density is started (see, FIG. 3A).

In the preheating zone Z1, the composite composition is heated at a temperature of 120° C. to 180° C., and the bulk density of the composite composition with a thickness of 100 mm is increased to a thickness of 3 mm. At this time, the temperature of the thermoplastic resin was a temperature 30° C. or more lower than the melting point (230° C.) of the thermoplastic resin.

In the heating zone Z2, the composite composition is heated at 180° C. to 340° C., and the thickness of 3 mm is reduced to 2.6 mm by upper and lower sub-rollers 71d and 73c arranged on the upstream side of the heating zone Z2 (see, FIG. 1). At this time, the thickness is reduced in the state of the composite composition temperature being higher than the melting point, but the decrement of the thickness is 0.4 mm and smaller than the ratio at which the bulk density was increased in the preheating zone Z1 (where the thickness is reduced from 100 mm to 3 mm, i.e., reduced by 97 mm).

Since the bulk density is increased in the first preheating zone Z1, the outflow of the thermoplastic resin in the heating zone Z2 was small, and the outflow of the thermoplastic resin was able to be suppressed to less than 20% based on the composite composition with a thickness of 100 mm prior to increase of the bulk density.

In the heating zone Z2, the composite composition increased in the bulk density at a temperature 50° C. or more higher than the melting temperature is heated and sandwiched by belts 63 and 65 from both of upper and lower sides (the spacing is constant) and therefore, the molten resin penetrates into the chopped fiber bundle or the like.

In the cooling zone Z3, the temperature is lowered from 330° C. to 100° C., and the thermoplastic resin in the molten state is solidified. In this way, a sheet-like fiber-reinforced plastic 51 with a thickness of 2.6 mm is obtained from a composite composition with a thickness of 100 mm. The results are shown in Table 1.

Because the entire fiber-reinforced plastic prepared was measured without regard to an outflow or the like of the resin as described above, the weight ratio (Wf) of the reinforcing fiber contained in the fiber-reinforced plastic was 46% that is the same as the weight ratio (Wf) of the reinforcing fiber contained in the composite composition.

### Example 2

A sheet-like fiber-reinforced plastic was prepared in the same manner as in Example 1 except that while keeping the weight per unit area of the composite composition unchanged at 3,600 g/m² (0.36 g/cm²), the ratio of the chopped fiber bundle defined by formula (2) regarding the average number (N) of fibers contained in the composite composition obtained was increased to 95 Vol % (the remaining is a single yarn or the like) and the thickness of the composite composition was thereby changed to 50 mm (the thickness was reduced). The results are shown in Table 1.

### Example 3

A fiber-reinforced plastic was prepared in the same manner as in Example 1 except that a polycarbonate resin (polycarbonate produced by TEIJIN LIMITED: L-1225WX, glass transition temperature: 150° C.) was used as the thermoplastic resin, the temperature of the preheating zone Z1 was set to a range of 150° C. to 180° C., the temperature of the heating zone Z2 was set to a range of 180° C. to 220° C., and the temperature of the cooling zone Z3 was set to a range of 220° C. to 100° C. The results are shown in Table 1.

### Example 4

A fiber-reinforced plastic was prepared in the same manner as in Example 1 except that while keeping the weight per unit area of the composite composition unchanged at 3,600 g/m² (0.36 g/cm²), the ratio of the chopped fiber bundle defined by formula (2) regarding the average number (N) of fibers contained in the composite composition obtained was decreased to 65 Vol % (the remaining is a single yarn or the like) and the thickness thereby changed to 130 mm. The results are shown in Table 1.

### Example 5

A fiber-reinforced plastic was prepared in the same manner as in Example 1 except that the composite composition with a thickness of 100 mm described in Example 1 was previously compressed at room temperature until reaching a thickness of 2.8 mm and then passed through the preheating zone Z1. The results are shown in Table 1.

### Example 6

A fiber-reinforced plastic was prepared in the same manner as in Example 1 except that the composite composition described in Example 1 was previously compressed at room temperature until reaching a thickness of 5 mm and then passed through the preheating zone Z1. The results are shown in Table 3.

### Example 7

A fiber-reinforced plastic was prepared in the same manner as in Example 1 except that the composite composition described in Example 1 was previously compressed at room temperature until reaching a thickness of 10 mm and then passed through the preheating zone Z1. The results are shown in Table 3.

### Example 8

A unidirectional material composed of a continuous carbon fiber (produced by Toho Tenax Co., Ltd., TENAX (registered trademark) STS40-24KS (fiber diameter: 7 μm, tensile strength: 4,000 MPa)) was prepared, put, thereon, a film of MXD nylon, Reny 6007 (registered trademark), produced by Mitsubishi Gas Chemical Company, Inc. such that a content of the resin was 100 parts by volume per 100 parts by volume of carbon fiber, and then bonded together by heated rollers at 260° C. to obtain a composite composition as a unidirectional material having a thickness of 1.0 mm and Vf of 50% (Wf: 61%). A sheet-like fiber-reinforced plastic was prepared in the same manner as in Example 1 except for using this composite composition in the form of a unidirectional material. The outflow amount of the resin was able to be suppressed, but the value of 1 was 0.90 and smaller than the value in Example 1. The results are shown in Table 3.

### Example 9

A fiber-reinforced plastic was prepared in the same manner as in Example 1 except that the thickness of the fiber-reinforced plastic was reduced to 2.5 mm by thickness reduction in the heating zone Z2. The value of β of the fiber-reinforced plastic was 1.00, but the rating of the outflow amount of the resin was C.

### Example 10

A fiber-reinforced plastic was prepared in the same manner as in Example 1 except that the resin used was changed to polybutylene terephthalate (DURANEX 700FP, produced by Polyplastics Co., Ltd.). The results are shown in Table 3.

### Comparative Example 1

A fiber-reinforced plastic was prepared in the same manner as in Example 1 except that the temperature condition of the preheating zone Z1 was set to a range of 280° C. to 300° C. and the temperature of the heating zone Z2 was set to a range of 300° C. to 340° C. The results are shown in Table 1.

### [Others]

### 1. Step of Increasing Bulk Density

### (1) Rate of Increase of Bulk Density

In Example 1, the bulk density was increased by compressing the composite composition with a thickness of 100 mm to a thickness of 3 mm. However, this Example is an exemplary embodiment, and the present embodiment is not limited thereto.

For example, the composite composition with a thickness of 100 mm may be compressed to a thickness larger than 3 mm, e.g., to a thickness of 5 mm or 10 mm, under the preheating temperature condition.

In addition, the thickness of the composite composition is also not limited to 100 mm and may be made to be a thickness of less than 100 mm or a thickness of more than 100 mm by increasing or decreasing the amount of the reinforcing fiber or the amount of the thermoplastic resin.

As a guide in increasing the bulk density, in the case of a composite composition where chopped reinforcing fibers are randomly arranged, the thickness is preferably from 60% to 2.5% relative to the thickness before the step. The density is preferably from 1.6 to 40 times the density before the step.

The lower limit is described below.

The composite composition in Example 1 was compressed to a thickness of 3 mm in the step of increasing the bulk density. If the composite composition is intended to be further compressed to a thickness of 2.5 mm or less in this step of increasing the bulk density, the outflow of the resin is increased, and the outflow amount of the resin becomes 20% or more relative to the composite composition prior to increase of the bulk density.

If the outflow amount of the thermoplastic resin exceeds 30%, the fiber volume content of the produced fiber-reinforced plastic varies widely or while doing nothing other than increasing the outflow amount, the density may not be increased.

When a composite composition formed by randomly depositing a large number of chopped fiber bundles or the like is compressed, not only a gap existing between chopped fiber bundles or the like becomes small but also the gap is filled with the thermoplastic resin and once the gap is eventually closed, the thermoplastic resin flows to the outside. From such a viewpoint, it is considered that when the gap contained in the composite composition is present in a ratio of 6 vol % or more relative to the composite composition, an outflow of the thermoplastic resin is suppressed.

### (2) Form of Resin

In the case where the thermoplastic resin in the composite composition is a powdered resin having an average particle diameter of 900 μm or less, when the composite composition is compressed, the resin enters a gap produced by deposition of chopped fiber bundles or the like in the composite composition. At this time, even if the resin powder is not softenable and deformable, as long as the particle diameter is small, the resin powder enters a gap.

When the bulk density is increased and the gap is closed by the resin powder, the resin powder cannot enter the gap. Therefore, when the bulk density is intended to be further increased, the resin powder flows out from the composite composition.

From such a viewpoint, although it may vary depending on, for example, the size of the resin powder, the shape of the resin powder, and the thickness of the chopped fiber bundle, or the like, the process until a gap in the composite composition is filled with the resin powder is specified as a step of increasing the bulk density, whereby an outflow of the resin powder to the outside can be suppressed.

Meanwhile, when the temperature of the composite composition is raised and the resin powder is softened, the resin becomes deformable, making it possible to enter a gap which the resin powder cannot enter. Therefore, compared with an undeformable resin powder, the bulk density can be increased without causing an outflow of the resin powder.

### 2. Heating Step

### (1) Presence or Absence of Heating Step

In Examples, the composite composition is heated at the “heating temperature” after the step of increasing the bulk density. By this heating, a molten resin (in the case of an amorphous resin, a softened resin) enters between reinforcing fibers, and a good fiber-reinforced plastic is obtained.

In the production method for obtaining a fiber-reinforced plastic from the composite composition, the heating step may or may not be performed after the step of increasing the bulk density. For example, in the case of compressing and molding the fiber-reinforced plastic into a predetermined shape, heating and pressurization are performed in the step of compression molding, whereby a molten resin (in the case of an amorphous resin, a softened resin) can infiltrate between reinforcing fibers and the same effect as that of the heating step is obtained.

### (2) Compression During Step

In Example 1, the composite composition with a thickness of 100 mm is thinned to 3 mm in the step of increasing the bulk density and is further thinned to a thickness of 2.6 mm in the heating step. However, in the heating step, unlike the step of increasing the bulk density, the thickness is not reduced by as large as 97 mm from 100 mm to 3 mm but is reduced only by 0.4 mm. Therefore, an outflow of the molten thermoplastic resin can also be suppressed.

In the heating step of Example 1, the thermoplastic resin is molten and a gap remains in the composite composition. Therefore, the molten resin can move into the inside of a gap along a fiber and in turn, an outflow of the molten resin to the outside is suppressed.

### 3. Cooling Step

In Examples, a cooling step of lowering the temperature of the composite composition is performed after the heating step. By this cooling, the productivity of a fiber-reinforced plastic can be enhanced. However, in the production method for obtaining a fiber-reinforced plastic from the composite composition, the cooling step may or may not be performed after the heating step. Furthermore, in the production method for obtaining a fiber-reinforced plastic from the composite composition, a cooling step may or may not be performed after the step of increasing the bulk density. This is because, for example, in the case of a double belt press of Example 1, when the fiber-reinforced plastic is delivered from upper and lower endless belts, an air at a temperature lower than that of the fiber-reinforced plastic is present therearound, and the fiber-reinforced plastic is cooled with the air.

TABLE 1

| | | | | | | | Comparative |
|---|---|---|---|---|---|---|---|
| | | Example 1 | Example 2 | Example 3 | Example 4 | Example 5 | Example 1 |
| Composite | Reinforcing fiber | carbon fiber | carbon fiber | carbon fiber | carbon fiber | carbon fiber | carbon fiber |
| Composition | Thermoplastic resin | polyamide 6 | polyamide 6 | polycarbonate | polyamide 6 | polyamide 6 | polyamide 6 |
| | Melting point | 225° C. | 225° C. | — | 225° C. | 225° C. | 225° C. |
| | Glass transition point | 48° C. | 48° C. | 150° C. | 48° C. | 48° C. | 48° C. |
| | Thickness, mm | 100 | 50 | 100 | 130 | 2.8 | 100 |
| | Wf: Weight ratio of reinforcing fiber | 46% | 46% | 46% | 46% | 46% | 46% |
| | contained in composite composition, % | | | | | | |
| | Carbon fiber density (g/cm³) | 1.79 | 1.79 | 1.79 | 1.79 | 1.79 | 1.79 |
| | Wm: Weight ratio of thermoplastic resin | 54% | 54% | 54% | 54% | 54% | 54% |
| | contained in composite composition, % | | | | | | |
| | Resin density (g/cm³) | 1.14 | 1.14 | 1.20 | 1.14 | 1.14 | 1.14 |
| | Density of thermoplastic resin*Wm + | 1.44 | 1.44 | 1.47 | 1.44 | 1.44 | 1.44 |
| | density of reinforcing fiber*Wf (g/cm³) | | | | | | |
| | Weight per unit area (g/cm²) | 0.36 | 0.36 | 0.36 | 0.36 | 0.36 | 0.36 |
| | Value of α | 0.025 | 0.050 | 0.024 | 0.019 | 0.89 | 0.025 |
| | Z1 (° C.) | 120-180 | 120-180 | 150-180 | 120-180 | 120-180 | 280-300 |
| | Z2 (° C.) | 180-340 | 180-340 | 180-220 | 180-340 | 180-340 | 300-340 |
| | Z3 (° C.) | 330-100 | 340-100 | 220-100 | 340-100 | 340-100 | 330-100 |
| Outflow amount of resin | | B | A | B | C | D | E |
| Fiber- | Thickness, mm | 2.6 | 2.6 | 2.6 | 2.6 | 2.6 | 2.6 |
| reinforced | Wf′: Weight ratio of reinforcing | 46% | 46% | 46% | 46% | 46% | 46% |
| plastic | fiber contained in fiber-reinforced | | | | | | |
| | plastic, % | | | | | | |
| | Wm′: Weight ratio of thermoplastic | 54% | 54% | 54% | 54% | 54% | 54% |
| | resin contained in fiber-reinforced | | | | | | |
| | plastic, % | | | | | | |
| | Value of β | 0.96 | 0.96 | 0.94 | 0.96 | 0.96 | 0.96 |

TABLE 2
The temperature distribution of the composite composition before and after increase of the bulk density in the production apparatus

| Function | | Preheating Zone Z1 | Heating Zone Z2 | Cooling Zone Z3 |
|---|---|---|---|---|
| Material | Crystalline | not more than melting point | not less than melting point | not more than melting point −50° C. |
| temperature | | −30° C. | | |
| | Amorphous | not more than glass transition | not less than glass transition temperature or | not more than glass transition |
| | | temperature +100° C. | temperature of preheating zone Z1, whichever is | temperature −30° C. |
| | | | higher | |

TABLE 3

| | | Example 6 | Example 7 | Example 8 | Example 9 | Example 10 |
|---|---|---|---|---|---|---|
| Composite | Reinforcing fiber | carbon fiber | carbon fiber | carbon fiber | carbon fiber | carbon fiber |
| Composition | | | | (continuous fiber) | | |
| | Thermoplastic resin | polyamide 6 | polyamide 6 | polyamide 6 | polyamide 6 | Polybutylene |
| | | | | | | terephthalate |
| | Melting point | 225° C. | 225° C. | 225° C. | 225° C. | 223° C. |
| | Glass transition point | 48° C. | 48° C. | 48° C. | 48° C. | 35° C. |
| | Thickness, mm | 5 | 10 | 1 | 100 | 100 |
| | Wf: Weight ratio of reinforcing fiber contained | 46% | 46% | 62% | 46% | 46% |
| | in composite composition, % | | | | | |
| | Carbon fiber density (g/cm³) | 1.79 | 1.79 | 1.79 | 1.79 | 1.79 |
| | Wm: Weight ratio of thermoplastic resin contained | 54% | 54% | 38% | 54% | 54% |
| | in composite composition, % | | | | | |
| | Resin density (g/cm³) | 1.14 | 1.14 | 1.14 | 1.14 | 1.31 |
| | Density of thermoplastic resin*Wm + density of | 1.44 | 1.44 | 1.54 | 1.44 | 1.53 |
| | reinforcing fiber*Wf (g/cm³) | | | | | |
| | Weight per unit area (g/cm²) | 0.36 | 0.36 | 0.13 | 0.36 | 0.36 |
| | Value of α | 0.50 | 0.250 | 0.810 | 0.025 | 0.024 |
| | Z1 (° C.) | 120-180 | 120-180 | 120-180 | 120-180 | 120-180 |
| | Z2 (° C.) | 180-340 | 180-340 | 180-340 | 180-340 | 180-340 |
| | Z3 (° C.) | 330-100 | 330-100 | 330-100 | 330-100 | 330-100 |
| Outflow amount of resin | | C | C | A | C | B |
| Fiber- | Thickness, mm | 2.6 | 2.6 | 0.9 | 2.5 | 2.6 |
| reinforced | Wf′: Weight ratio of reinforcing fiber | 46% | 46% | 62% | 46% | 46% |
| plastic | contained in fiber-reinforced plastic, % | | | | | |
| | Wm′: Weight ratio of thermoplastic resin | 54% | 54% | 38% | 54% | 54% |
| | contained in fiber-reinforced plastic, % | | | | | |
| | Value of β | 0.96 | 0.96 | 0.90 | 1.00 | 0.90 |

### INDUSTRIAL APPLICABILITY

The fiber-reinforced plastic obtained by the production method of the present invention has excellent continuous productivity and can be used, for example, in applications such as a structural part for an automobile, this making certain of vehicle body weight reduction, or the like.

### DESCRIPTION OF REFERENCE NUMERALS AND SIGNS

1. Composite composition
7. Chopped fiber bundle
13. Cutting unit
51. Fiber-reinforced plastic
53. Production apparatus of fiber-reinforced plastic
55/57, 59/61. One set of main rollers
63. Upper endless belt
65. Lower endless belt
71. Lower sub-roller
73. Upper sub-roller
71a to 71i. Lower sub-rollers
73a to 73g. Upper sub-rollers
75. Melting point in case of crystalline resin or glass transition temperature in case of amorphous resin
Z0. Before preheating zone
Z1. Preheating zone
Z2. Heating zone
Z3. Cooling zone
101. Composite composition
103. Reinforcing fiber mat
105. Thermoplastic resin sheet
107. Discharge nozzle
109. Conveyor
111. Screw extruder
113. T-die
113a. End part (in FIG. 2, upper end) opposite the side part in the vertical portion of T shape
113b. Side part of T shape (in FIG. 2, lower end)
115. Hopper
117. Pulverized material
119. Heating cylinder
121. Screw body
123. Nozzle
131. Device for increasing bulk density
133. Fiber-reinforced plastic
135, 137. A pair of rollers

1. A production method for producing a sheet-like fiber-reinforced plastic from a composite composition containing a thermoplastic resin and a reinforcing fiber,
wherein a bulk density of the composite composition is increased at not more than a temperature 30° C. lower than a melting point when the thermoplastic resin is crystalline or at not more than a temperature 100° C. higher than a glass transition temperature when the thermoplastic resin is amorphous, and
the composite composition increased in the bulk density is heated at a temperature the same as or higher than the melting point when the thermoplastic resin is crystalline, or at a temperature the same as or higher than the glass transition temperature or the temperature at the time of increasing the bulk density, whichever is higher, when the thermoplastic resin is amorphous.

2. The production method of a fiber-reinforced plastic according to claim 1,
wherein a step of increasing the bulk density is finished before 20% or more of the thermoplastic resin flows out relative to the composite composition prior to increase of the bulk density.

3. (canceled)

4. The production method of a fiber-reinforced plastic according to claim 1,
wherein the heating is performed while maintaining a state of the bulk density being increased.

5. The production method of a fiber-reinforced plastic according to claim 1,
wherein the reinforcing fiber is a chopped discontinuous fiber.

6. The production method of a fiber-reinforced plastic according to claim 1,
wherein the reinforcing fiber contains chopped fibers randomly arranged in a two-dimensional direction.

7. The production method of a fiber-reinforced plastic according to claim 1,
wherein the reinforcing fiber is a unidirectional continuous fiber.

8. The production method of a fiber-reinforced plastic according to claim 1,
wherein the step of increasing the bulk density is performed on the composite composition that is moving.

9. The production method of a fiber-reinforced plastic according to claim 1,
wherein a thickness of the composite composition satisfies the following formula (x):
α=weight per unit area of composite composition/{(density of thermoplastic resin*Wm+density of reinforcing fiber*Wf)*thickness of composite composition} formula (x)
wherein Wm represents weight ratio of the thermoplastic resin contained in the composite composition,
Wf represents weight ratio of the reinforcing fiber contained in the composite composition, and
α is from 0.020 to 0.82.

10. The production method of a fiber-reinforced plastic according to claim 1,
wherein a thickness of the fiber-reinforced plastic satisfies the following formula (y):
β=weight per unit area of composite composition/{(density of thermoplastic resin*Wm′+density of reinforcing fiber*Wf′)*thickness of fiber-reinforced plastic} formula (y)
wherein Wm′ represents weight ratio of the thermoplastic resin contained in the fiber-reinforced plastic,
Wf′ represents weight ratio of the reinforcing fiber contained in the fiber-reinforced plastic, and
β is 0.82 or more.
